(19) United States
(12) Patent Application Publication
(10) Pub. No.: US 2013/0284124 A1
(43) Pub. Date: Oct. 31, 2013

(54) Enclosed Hydraulic Auxiliary Power Unit

(71) Applicants: Matthew Austin Conques, Scott, LA (US); Kenneth James Conques, Scott, LA (US)

(72) Inventors: Matthew Austin Conques, Scott, LA (US); Kenneth James Conques, Scott, LA (US)

(21) Appl. No.: 13/929,966

(22) Filed: Jun. 28, 2013

(51) Int. Cl. F02B 63/04

(52) U.S. Cl. CPC F02B 63/04
USPC 123/2

(57) ABSTRACT

A power unit for generation of electric current is disclosed. A hydraulic motor, powered by a source of pressurized hydraulic fluid, is coupled to and turns a generator, producing direct or alternating electric current. The hydraulic motor and generator are mounted on a base section, which in turn can be mounted on a desired surface, for example a trailer used in connection with hydraulic fracturing operations on oil and gas wells. A cover is hingedly connected to the base section, and in a first position is swung into a closed position covering the hydraulic motor and electric generator. With the cover in a second, open position, easy access is had to the the hydraulic motor and electric generator. Instrumentation showing operating conditions of the hydraulic motor and electric generator may be mounted in one or more openings in the cover.

### BACKGROUND

### Field of the Invention

This invention relates to apparatus and method for generating electrical current at remote work locations.

In the course of drilling and/or completion operations on oil and gas wells, in particular conducting hydraulic fracturing or “frac” operations on said wells, it is desirable to have a source of electric current on location. However, well locations are frequently distant from any electrical power grid. Generators, driven by internal combustion engines, are therefore frequently used, but pose issues with space limitations at the worksite.

In various field operations, including but not limited to so-called “frac” operations, diesel engine driven fluid pumps provide pressurized hydraulic fluid for a variety of purposes, for example lubrication oil for gear boxes and power ends on pumps. There is typically a surplus capacity of hydraulic fluid which could be used for any desired purpose.

### SUMMARY OF THE INVENTION

This invention comprises an electric current generator (“generator”), which is coupled to and driven by a hydraulic motor. As used herein, the term “generator” includes all devices which produce either direct or alternating current, commonly known as both “generators” and “alternators.” The generator/motor combination is preferably mounted on an equipment trailer or similar movable structure, for example a trailer on which is mounted various equipment used in carrying out hydraulic fracturing on oil/gas wells. The generator/motor combination is enclosed, preferably within a box-shaped structure having a base portion and a hinged cover. The base portion and the cover preferably comprise one or more openings into which instrumentation can be mounted. The hinged cover covers the coupling between the generator and the motor, and increases safety by fully enclosing the generator. Preferably, the back panel of the box-shaped structure is open, and when mounted slightly elevated from the surface of a trailer or similar structure, allows air flow through the box for ventilation.

### BRIEF DESCRIPTION OF THE DRAWINGS

FIGS. 1A and 1B are side and perspective views of an equipment trailer having the hydraulic auxiliary power unit of the present invention mounted thereon.

FIG. 1 is a perspective view of a hydraulic auxiliary power unit embodying the principles of the present invention, with the hinged cover in an open position and various aspects of the internal parts of the unit visible.

FIG. 2 is a perspective view of a hydraulic auxiliary power unit embodying the principles of the present invention, with the hinged cover closed.

FIG. 3 is a top view of a hydraulic auxiliary power unit embodying the principles of the present invention, with the hinged cover opened and various aspects of the internal parts of the unit visible. It is understood that the hydraulic auxiliary power unit may be mounted in various orientations, therefore this view may in fact be from multiple positions (whether “top,” “side,” etc.).

### DESCRIPTION OF THE PRESENTLY PREFERRED EMBODIMENT(S)

While various embodiments of the hydraulic auxiliary power unit are possible within the scope of the present invention, with reference to the drawings some of the presently preferred embodiments can be described.

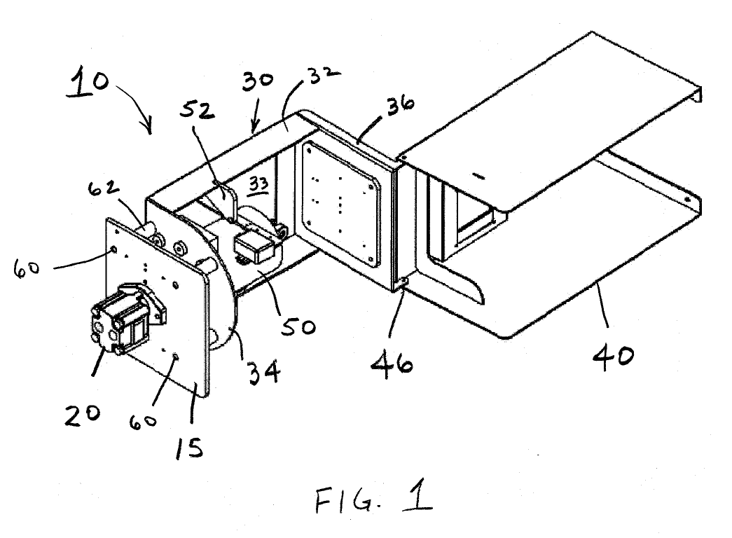

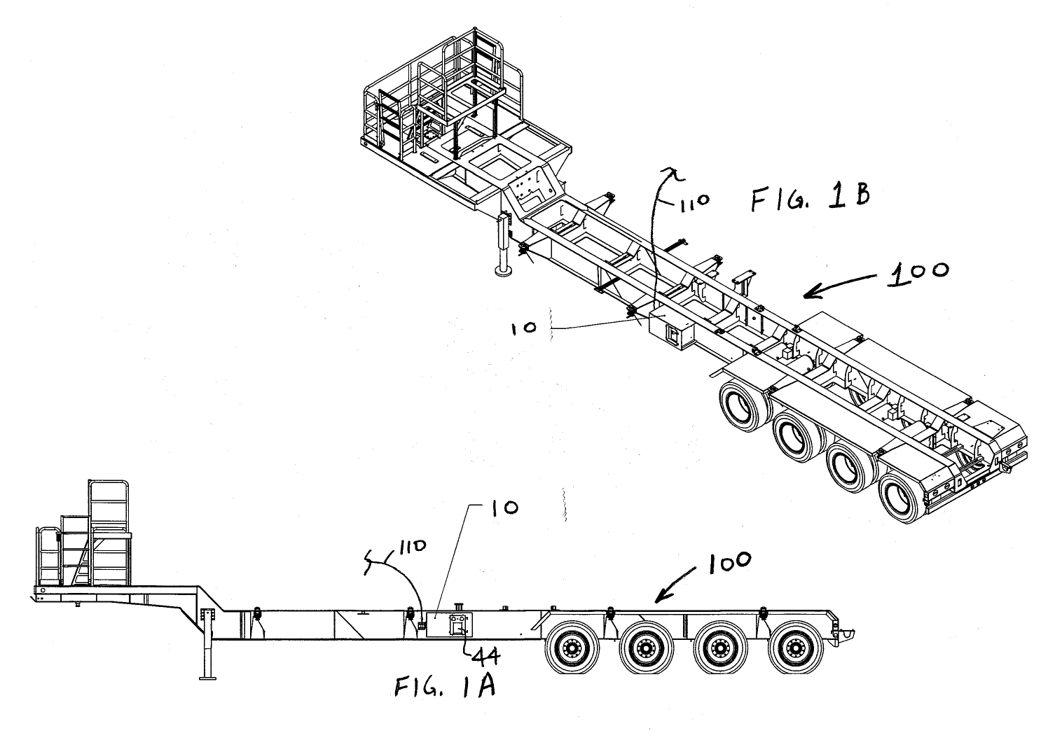

FIGS. 1A and 1B show an exemplary mounting of the hydraulic auxiliary power unit 10 on an equipment trailer 100. Equipment trailer 100, in the pictured embodiment, is a wheeled trailer adapted to be pulled by a truck or tractor. A variety of equipment may be mounted on trailer 100, such as pumps, engines, etc. as necessary for the job. Hydraulic auxiliary power unit 10 is preferably mounted on a side rail or member, as shown, but may be mounted in other locations, preferably not interfering with other equipment or operations. It is to be understood that the mounting shown in FIGS. 1A and 1B is only by way of example; power unit 10 may be mounted in other locations on trailer 100, or may be mounted in a fixed location such as on a wall, building, on other equipment, etc. Use is not restricted to oilfield work, but instead the unit may be used in any setting where electric current is needed and a pressurized hydraulic fluid source is available.

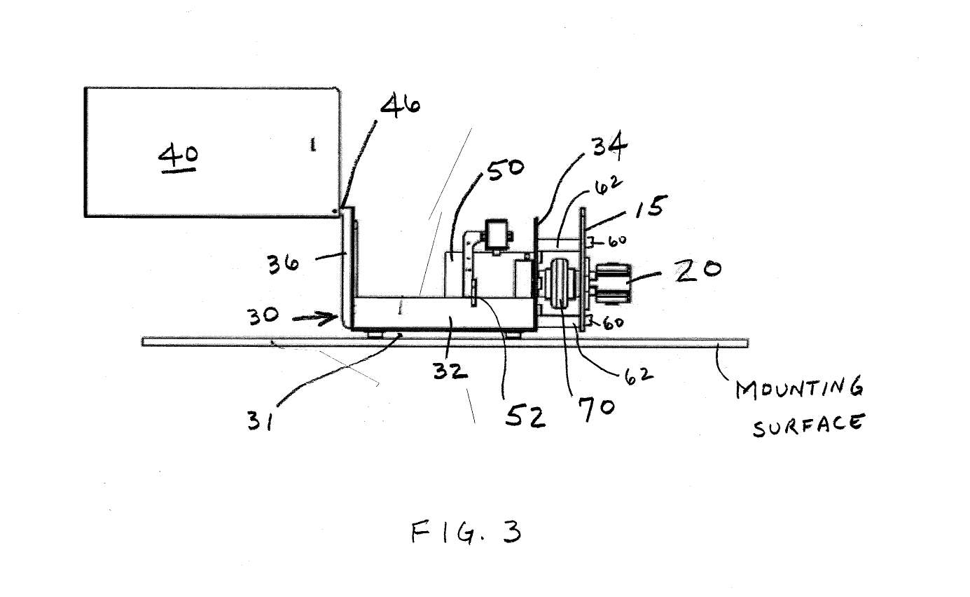

Referring to FIGS. 1 and 3, power unit 10 comprises a base section 30, comprising base wall 32, a first end wall 34 and a second end wall 36. As can be seen in FIGS. 1 and 3, in the illustrated embodiment cover 40 is hingedly connected to second end wall 36 by a simple pin hinge 46; however, it is understood that various other arrangements of connecting cover 40 to base section 30 could be used. First end wall 34 serves as a mount for generator 50, which may have one or more additional braces 52 to provide a secure mounting. Support plate 15 may be attached to first end wall 34 by bolts 60 with spacers 62 therebetween, as desired. A coupling 70, of a type well known in the relevant field, operatively connects motor 20 and generator 50. FIG. 3 shows power unit 10 mounted on a mounting surface, for example on equipment trailer 100. As can be seen in FIG. 3, power unit 10 is preferably mounted such that a gap 31 exists between base wall 32 and the surface on which power unit 10 is mounted. Air gap 31, combined with opening 33 (see FIG. 1) in base wall 32, permits air flow through power unit 10 for cooling.

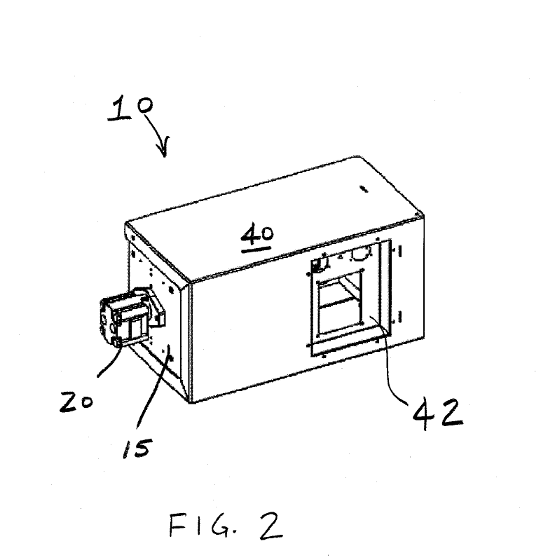

FIG. 2 is a perspective view of the power unit 10, showing motor 20 positioned on a support plate 15 and cover 40 closed. Preferably, cover 40 has an opening 42, into which may be mounted various types of instrumentation. Multiple openings 42 may be in place, depending upon operational requirements and other considerations.

With regard to materials of manufacture, power unit 10 may be made of materials well known in the relevant art, for example plate and sheet metals of suitable composition and dimensions. Non-metals, such as composites of different types, may be suitable for some parts of the unit. With regard to dimensions, the various components of power unit 10 may be sized and shaped to accommodate any desired motor/generator combinations.

### Application and Use of the Hydraulic Auxiliary Power Unit

While power unit 10 may have applicability in a number of settings, one possible use is in connection with oil and gas drilling and completion operations, more specifically in connection with oil/gas well hydraulic fracturing. Such operations are frequently conducted in somewhat remote locations, where utility electric power is unavailable. In order to generate electric current, previous solutions employed generators driven by internal combustion engines. Costs and operational considerations, including space limitations, with internal combustion engine generators are well known. However, in hydraulic fracturing operations, there is frequently a source of pressurized hydraulic fluid available; power unit 10 enables use of this hydraulic fluid source to power hydraulic motor 20, and consequently generator 50 to produce electric current. Referring again to FIGS. 1A and 1B, an exemplary operational setting for power unit 10 is shown, in which power unit 10 is mounted on a truck-pulled trailer 100, at a location convenient for access by workers. Hydraulic lines 110 are run to generator 50 and a suitable volume of hydraulic fluid run through hydraulic motor 20. Electric current from generator 50 is routed to a needed location. Instruments 44 can be mounted in opening 42, so as to monitor operating conditions of hydraulic motor 20 and generator 50. When necessary, cover 40 can be easily opened for access to hydraulic motor 20 and generator 50, at other times, those mechanical components are covered from inadvertent contact by workers, weather, etc.

### CONCLUSION

While the preceding description contains many specificities, it is to be understood that same are presented only to describe some of the presently preferred embodiments of the invention, and not by way of limitation. Changes can be made to various aspects of the invention, without departing from the scope thereof. For example, dimensions and shapes of the various components, including base section 30 and cover 40, can be altered to suit particular applications; cover 40 can be hinged from either end, top or bottom of base section 30; cover 40 can be a “snap on” arrangement, with a friction fit or other means of placement on base section 30, rather than a hinged connection, and when desired is removed completely from base section 30 for access; cover 40 can attached to base section 30 by a sliding type arrangement, and when desired slid open to provide access to the hydraulic motor and/or electric current generator.

Therefore, the scope of the invention is to be determined not by the illustrative examples set forth above, but by the appended claims and their legal equivalents.

I claim:

1. An apparatus for generation of electric current, comprising:
a base section and first and second end walls attached to said base section;
an electric generator, mounted on said base section;
a hydraulic motor coupled to said electric generator; and
a cover hingedly connected to said base section, said cover movable between a first position wherein said electric generator and said hydraulic motor are at least partially enclosed within said cover, said base section and said end walls, and a second position wherein said electric generator and said hydraulic motor are exposed.

2. The apparatus of claim 1, wherein said cover further comprises one or more openings therein, and wherein said apparatus further comprises instrumentation disposed in said openings, said instrumentation connected to and providing information regarding said hydraulic motor and said electric generator.

3. An apparatus for generation of electric current, particularly suitable for use in connection with oil and gas well hydraulic fracturing operations, comprising:
a base section and first and second end walls attached to said base section;
an electric generator, mounted on said base section;
a hydraulic motor coupled to said electric generator; and
a cover movably connected to said base section, said cover having a first position wherein said electric generator and said hydraulic motor are at least partially enclosed within said cover, said base section and said end walls, and a second position wherein said electric generator and said hydraulic motor are exposed for access.

4. The apparatus of claim 3, wherein said cover is hingedly connected to said base section.

5. The apparatus of claim 3, wherein said cover may be completely removed from said base section.

6. The apparatus of claim 3, wherein said cover is slidably mounted on said base section, and slidable between said first and second positions.

7. The apparatus of claim 3, wherein said apparatus is mounted on a trailer positioned at an oil and/or gas wellsite.

8. An apparatus for generation of electric current, comprising:
a mobile equipment trailer;
a structure comprising a base section and first and second end walls attached to said base section, said structure mounted on said equipment trailer spaced from a surface of said trailer, providing a gap between said structure and said equipment trailer;
an electric generator, mounted on said base section;
a hydraulic motor coupled to said electric generator; and
a source of pressurized hydraulic fluid operatively connected to said hydraulic motor.
